(19) United States
(12) Patent Application Publication
(10) Pub. No.: US 2024/0094935 A1
(43) Pub. Date: Mar. 21, 2024

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Terue WATANABE, Tokyo (JP); Yutaka OISHI, Tokyo (JP); Yuko MASUDA, Tokyo (JP); Misaki OTSUKA, Tokyo (JP)

(21) Appl. No.: 18/356,170

(22) Filed: Jul. 20, 2023

(30) Foreign Application Priority Data
Sep. 16, 2022 (JP) 2022-148540

(51) Int. Cl. G06F 3/06

(52) U.S. Cl. CPC G06F 3/0647; G06F 3/0619; G06F 3/0632; G06F 3/0686

(57) ABSTRACT

An information processing apparatus determines, for each of packed objects recorded on one data-migration-source magnetic tape, whether or not to regenerate the packed objects by using objects included in the packed objects, generates a second packed object by using objects included in a first packed object determined as being regenerated, performs control of distributing and recording a plurality of second packed objects and parity data on a plurality of magnetic tapes, and performs control of recording a packed object determined as not being regenerated on a magnetic tape different from the data-migration-source magnetic tape.

### CROSS-REFERENCE TO RELATED APPLICATIONS

This application claims priority under 35 U.S.C. § 119 from Japanese Patent Application No. 2022-148540, filed on Sep. 16, 2022, the entire disclosure of which is incorporated herein by reference.

### BACKGROUND

### 1. Technical Field

The present disclosure relates to an information processing apparatus, an information processing method, and an information processing program.

### 2. Description of the Related Art

WO2021/181739A discloses a technique of grouping and recording a plurality of pieces of data on a magnetic tape.

JP2021-117772A discloses a technique of generating parity data by using a plurality of pieces of data and distributing and recording the plurality of pieces of data and the parity data on a plurality of magnetic tapes.

### SUMMARY

In a case of migrating data from a data-migration-source magnetic tape to a data-migration-destination magnetic tape, as a frequency of replacement of magnetic tapes with respect to a tape drive increases, a data migration time is increased.

The present disclosure has been made in view of the above circumstances, and an object of the present disclosure is to provide an information processing apparatus, an information processing method, and an information processing program capable of reducing a frequency of replacement of magnetic tapes with respect to a tape drive during data migration.

According to a first aspect, there is provided an information processing apparatus comprising: at least one processor, in which the processor is configured to: determine, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data; generate a second packed object by using objects included in a first packed object determined as being regenerated; generate parity data by using a plurality of second packed objects; perform control of distributing and recording the plurality of second packed objects and the parity data on the plurality of magnetic tapes; and perform control of recording a packed object determined as not being regenerated on a magnetic tape different from the data-migration-source magnetic tape.

According to a second aspect, in the information processing apparatus according to the first aspect, the processor is configured to further transfer the first packed object used for generating the second packed object to a magnetic tape different from the data-migration-source magnetic tape in a case where a purpose of data migration is to initialize and reuse the data-migration-source magnetic tape.

According to a third aspect, in the information processing apparatus according to the second aspect, the plurality of packed objects and the parity data generated from the plurality of packed objects are regarded as one group, and the processor is configured to: set, in a case where there are magnetic tapes that are designated as data migration sources and are designated as data migration targets other than the data-migration-source magnetic tape, during data migration processing of the data-migration-source magnetic tape, as a data migration order of magnetic tapes designated as data migration sources other than the data-migration-source magnetic tape, an order in which the number of recorded packed objects belonging to the same group as the packed object recorded on the data-migration-source magnetic tape during the data migration processing is large.

According to a fourth aspect, in the information processing apparatus according to any one aspect of the first aspect to the third aspect, the plurality of packed objects and the parity data generated from the plurality of packed objects are regarded as one group, and the processor is configured to: determine, in a case where a purpose of data migration is data migration from relatively-old magnetic tapes to relatively-new magnetic tapes, not to regenerate a packed object by using objects included in the packed object recorded on the data-migration-source magnetic tape in a case where a packed object belonging to the same group as the packed objects recorded on the data-migration-source magnetic tape is recorded on a relatively-new magnetic tape.

According to a fifth aspect, in the information processing apparatus according to any one aspect of the first aspect to the fourth aspect, the processor is configured to: determine whether or not to regenerate a packed object by using objects included in the packed object, based on a deletion rate of the objects in the packed object recorded on the data-migration-source magnetic tape.

According to a sixth aspect, there is provided an information processing method executed by a processor of an information processing apparatus, the method comprising: determining, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data; generating a second packed object by using objects included in a first packed object determined as being regenerated; generating parity data by using a plurality of second packed objects; performing control of distributing and recording the plurality of second packed objects and the parity data on the plurality of magnetic tapes; and performing control of recording a packed object determined as not being regenerated on a magnetic tape different from the data-migration-source magnetic tape.

According to a seventh aspect, there is provided an information processing program for causing a processor of an information processing apparatus to execute a process comprising: determining, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data; generating a second packed object by using objects included in a first packed object determined as being regenerated; generating parity data by using a plurality of second packed objects; performing control of distributing and recording the plurality of second packed objects and the parity data on the plurality of magnetic tapes; and performing control of recording a packed object determined as not being regenerated on a magnetic tape different from the data-migration-source magnetic tape.

According to the present disclosure, it is possible to reduce a frequency of replacement of magnetic tapes with respect to a tape drive during data migration.

### BRIEF DESCRIPTION OF THE DRAWINGS

FIG. 1 is a block diagram illustrating an example of a configuration of an information processing system.

FIG. 2 is a diagram for explaining an object.

FIG. 3 is a diagram for explaining a packed object.

FIG. 4 is a block diagram illustrating an example of a hardware configuration of an information processing apparatus.

FIG. 5 is a diagram for explaining a recording state of a packed object and parity data on a magnetic tape.

FIG. 6 is a block diagram illustrating an example of a functional configuration of the information processing apparatus.

FIG. 7 is a diagram for explaining processing of determining whether or not to regenerate a packed object.

FIG. 8 is a diagram for explaining processing of regenerating a packed object.

FIG. 9 is a diagram for explaining processing of generating parity data.

FIG. 10 is a diagram for explaining recording processing of a packed object and parity data on a magnetic tape.

FIG. 11 is a diagram for explaining migration processing of a packed object determined not to be regenerated.

FIG. 12 is a flowchart illustrating an example of data migration processing.

FIG. 13 is a diagram for explaining transfer processing of a first packed object according to a modification example.

FIG. 14 is a diagram for explaining an order of data migration according to a modification example.

FIG. 15 is a diagram for explaining processing of determining whether or not to regenerate a packed object according to a modification example.

### DETAILED DESCRIPTION

Hereinafter, an example of an embodiment for performing a technique according to the present disclosure will be described in detail with reference to the drawings.

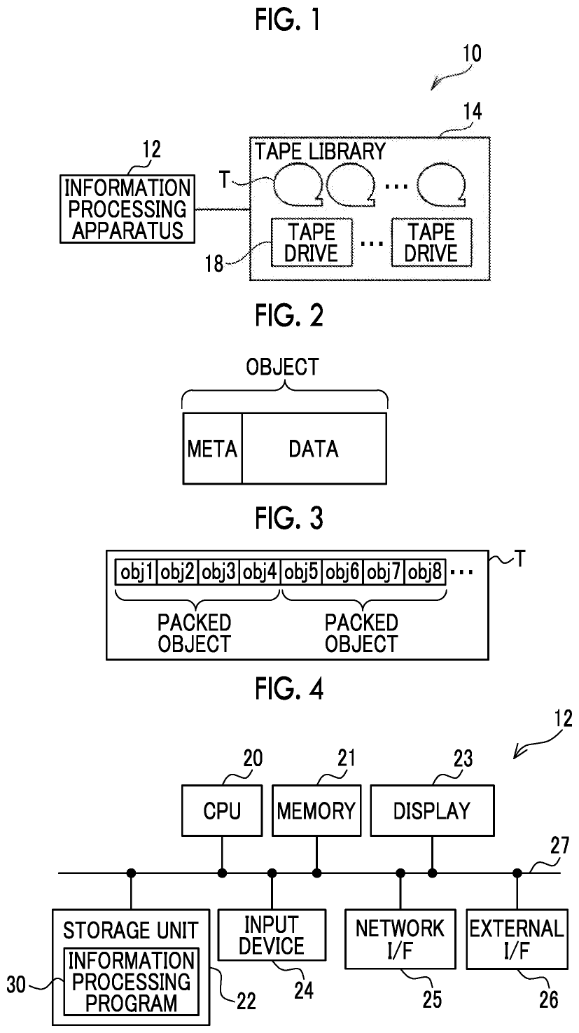

First, a configuration of an information processing system 10 according to the present embodiment will be described with reference to FIG. 1. As illustrated in FIG. 1, the information processing system 10 includes an information processing apparatus 12 and a tape library 14. Examples of the information processing apparatus 12 include a server computer and the like.

The tape library 14 includes a plurality of slots (not illustrated) and a plurality of tape drives 18, and each slot houses a magnetic tape T as an example of a recording medium. Each tape drive 18 is connected to the information processing apparatus 12. The tape drive 18 writes or reads data to or from the magnetic tape T under a control of the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally housed.

In the present embodiment, as an example, as illustrated in FIG. 2, as a unit for handling data to be recorded on the magnetic tape T, an example of an embodiment in which an object including data to be saved by a user such as document data and image data and metadata related to the data is applied will be described. In the example of FIG. 2, the metadata is referred to as “meta”. A storage system that handles the object is called an object storage system. The metadata includes, for example, identification information of an object such as an object key, and attribute information such as an object name, a data size, and a time stamp. The recording order of the data and the metadata when recording the object on the magnetic tape T is not particularly limited, and may be an order of the metadata and the data or an order of the data and the metadata.

In addition, in the present embodiment, as illustrated in FIG. 3 as an example, one or more objects are recorded on the magnetic tape T in units of objects (hereinafter, referred to as a “packed object”) grouped according to a predetermined rule (hereinafter, referred to as a “packing rule”). This aims to reduce overhead due to issuance of a command for instructing the tape drive 18 to record an object in a case where the information processing apparatus 12 records the object on the magnetic tape T. The packed object is an example of data recorded on the magnetic tape T designated as a target of data migration according to the disclosed technology. “obj” in FIG. 3 represents an object. FIG. 3 illustrates an example in which one packed object includes four objects. On the other hand, the present embodiment is not limited thereto. One packed object may include three or less objects, or may include five or more objects. In addition, the number of objects included in the packed object may not be the same.

Examples of the packing rule include a rule for grouping a plurality of objects including pieces of data having the same extension into the same packed object and a rule for grouping a plurality of objects that are likely to be read at the same time into the same packed object. In addition, examples of the packing rule include a rule for grouping a plurality of objects into one packed object such that a size of one packed object is equal to or larger than a predetermined lower limit value and is smaller than a predetermined upper limit value. In addition, examples of the packing rule include a rule for grouping a plurality of objects into one packed object such that the number of objects included in one packed object is equal to or larger than a predetermined lower limit value and is smaller than a predetermined upper limit value. In addition, a plurality of packing rules may be combined.

Next, a hardware configuration of the information processing apparatus 12 according to the present embodiment will be described with reference to FIG. 4. As illustrated in FIG. 4, the information processing apparatus 12 includes a central processing unit (CPU) 20, a memory 21 as a temporary memory area, and a non-volatile storage unit 22. Further, the information processing apparatus 12 includes a display 23 such as a liquid crystal display, an input device 24 such as a keyboard and a mouse, a network interface (UF) 25 connected to a network, and an external OF 26 to which each tape drive 18 is connected. The CPU 20, the memory 21, the storage unit 22, the display 23, the input device 24, the network OF 25, and the external OF 26 are connected to a bus 27. The CPU 20 is an example of a processor.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30.

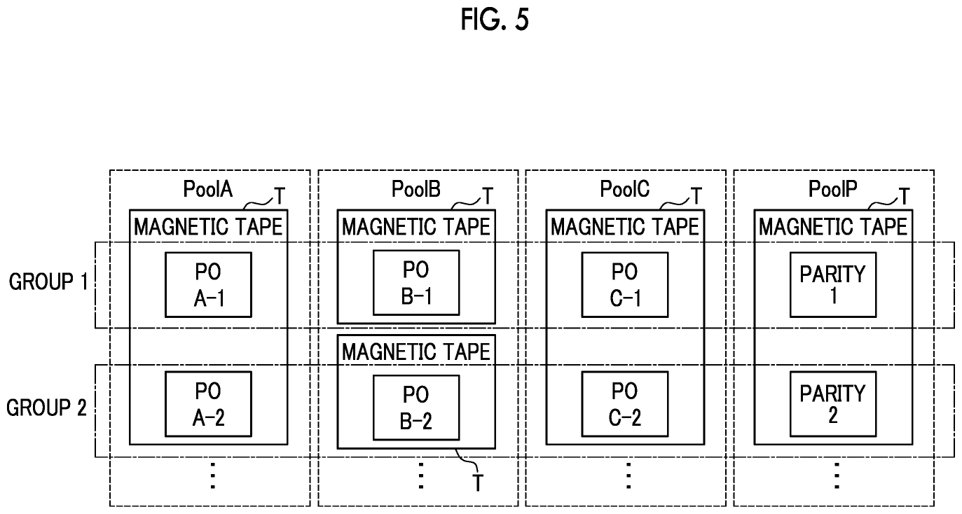

On the other hand, the information processing apparatus 12 according to the present embodiment has a function of migrating a packed object recorded on the magnetic tape T to another magnetic tape T. Hereinafter, in the data migration, a magnetic tape T as a data migration source is referred to as a migration source tape, and a magnetic tape T as a data migration destination is referred to as a migration destination tape. A packed object as a migration target that is recorded on the migration source tape will be described with reference to FIG. 5. In the present embodiment, parity data is generated using a plurality of packed objects in order to ensure redundancy of the packed objects. In the present embodiment, in order to make the description easy to understand, a configuration in which one piece of parity data is generated from three packed objects (so-called a configuration of 3D+1P) will be described as an example. The combination of the number of packed objects and the number of parity data is not limited to this example. In addition, the information processing apparatus 12 handles the three packed objects and the one piece of parity data generated from the three packed objects as belonging to one group. This group may also be referred to as a parity group.

As illustrated in FIG. 5, in the present embodiment, the same number of storage pools as a total value of the number of packed objects and the number of pieces of parity data in one group are prepared, and each storage pool is configured by a plurality of magnetic tapes T. In a case where the data is recorded on the magnetic tape T, a storage pool as a data recording destination is designated, and the data is recorded on a certain magnetic tape T included in the designated storage pool.

In the present embodiment, three packed objects and one piece of parity data belonging to one group are distributed and recorded in four storage pools, that is, four magnetic tapes T. In FIG. 5, “PoolA”, “PoolB”, “PoolC”, and “PoolP” represent storage pools. “PoolA”, “PoolB”, and “PoolC” are storage pools for recording packed objects, and “PoolP” is a storage pool for recording parity data.

In FIG. 5, “PO” represents the packed object, and “parity” represents the parity data. In FIG. 5, the one-letter alphabet after “PO” is for identifying the packed objects in the same group. In FIG. 5, the number after the one-letter alphabet and the number after “parity” are for identifying the group. That is, for example, in FIG. 5, “parity 1” is parity data generated using “PO A-1”, “PO B-1”, and “PO C-1”. With the configuration as described above, even in a case where one magnetic tape T is not available, it is possible to restore the packed object recorded on the one magnetic tape T that is not available from the two packed objects and the one piece of parity data recorded on the remaining three magnetic tapes T.

In addition, in the present embodiment, since the storage pool function is used, recording states of pieces of data on the magnetic tapes T between the storage pools are not always the same. For example, as illustrated in FIG. 5, in “PoolA”, “PO A-1” and “PO A-2” may be recorded on the same magnetic tape T, and in “PoolB”, “PO B-1” and “PO B-2” may be recorded on different magnetic tapes T.

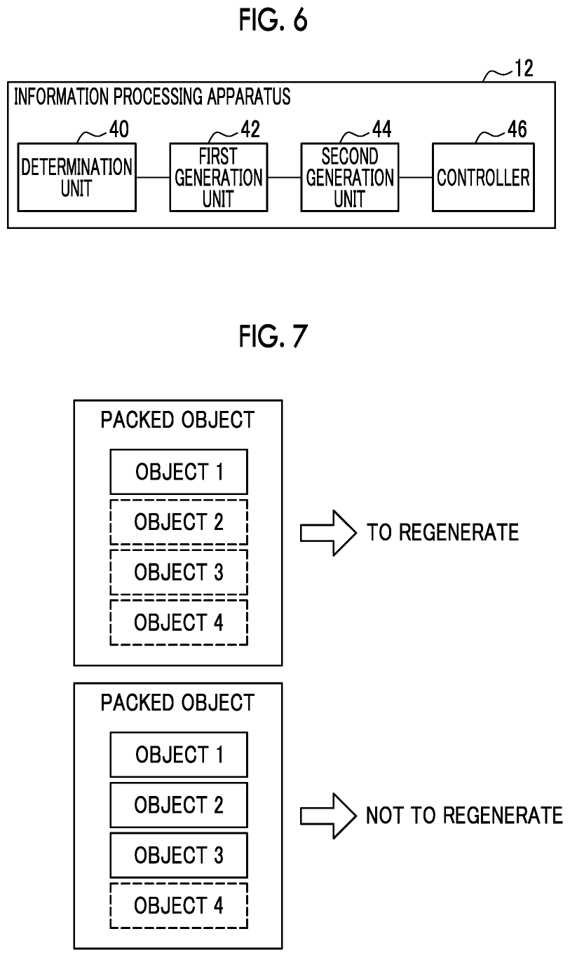

Next, a functional configuration of the information processing apparatus 12 according to the present embodiment will be described with reference to FIG. 6. As illustrated in FIG. 6, the information processing apparatus 12 includes a determination unit 40, a first generation unit 42, a second generation unit 44, and a controller 46. In a case where the CPU 20 executes the information processing program 30, the information processing apparatus 12 functions as the determination unit 40, the first generation unit 42, the second generation unit 44, and the controller 46.

The determination unit 40 determines whether or not to regenerate a packed object by using objects included in the packed object, for each packed object recorded on one migration source tape designated as a data migration target among the plurality of magnetic tapes T. In the present embodiment, the determination unit 40 determines whether or not to regenerate a packed object by using objects included in the packed object, based on a deletion rate of the objects in the packed object recorded on the migration source tape.

In the information processing system 10 according to the present embodiment, an object for which a deletion request is input by a user, an administrator, or the like of the information processing system 10 is not deleted from the magnetic tape T at a timing when the deletion request is input, and deletion information indicating that the object is deleted is assigned to the object. The deletion information is saved in association with the object, for example, in a database for managing the object or an area for recording management information of the magnetic tape T on which the object is recorded. This is because it is difficult to delete, from the magnetic tape T, only a specific object among the objects recorded on the magnetic tape T. The deletion rate of the objects in the packed object represents a rate at which the objects in the packed object are deleted.

In the present embodiment, the determination unit 40 derives, as the deletion rate, a ratio of the number of objects to which pieces of the deletion information are assigned to the total number of objects included in the packed object. The determination unit 40 may derive, as the deletion rate, a ratio of a total size of objects to which pieces of the deletion information are assigned to a total size of objects included in the packed object. In addition, as illustrated in FIG. 7, the determination unit 40 determines to, for a packed object of which the deletion rate is equal to or higher than a threshold value, regenerate the packed object by using objects included in the packed object. On the other hand, the determination unit 40 determines not to, for a packed object of which the deletion rate is lower than the threshold value, regenerate the packed object by using objects included in the packed object.

In FIG. 7, a solid-lined object represents an object to which the deletion information is not assigned, and a broken-lined object represents an object to which the deletion information is assigned. In addition, FIG. 7 illustrates an example in a case where the threshold value is set to 50%. Therefore, in the example of FIG. 7, it is determined to regenerate the packed object in which pieces of the deletion information are assigned to three objects among four objects, that is, the packed object having a deletion rate of 75%. In addition, in the example of FIG. 7, it is determined not to regenerate the packed object in which the deletion information is assigned to one object among four objects, that is, the packed object having a deletion rate of 25%.

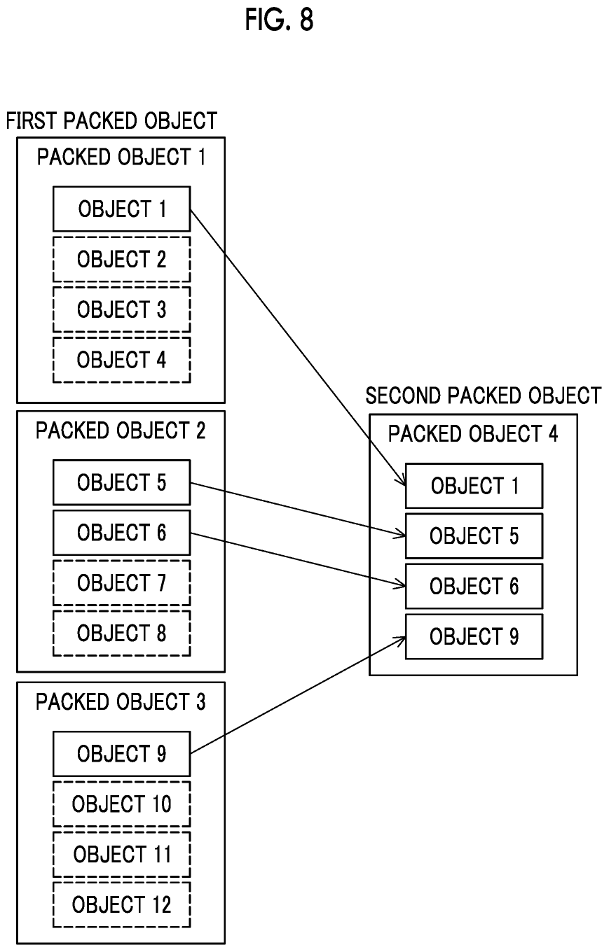

The first generation unit 42 generates a packed object (hereinafter, referred to as “second packed object”) by using the objects included in the packed object (hereinafter, referred to as “first packed object”) determined by the determination unit 40 as being regenerated. As illustrated in FIG. 8, in the present embodiment, the first generation unit 42 generates a second packed object by using only the objects to which pieces of the deletion information are not assigned among the objects included in the first packed object according to the packing rule described above. In FIG. 8, a solid-lined object represents an object to which the deletion information is not assigned, and a broken-lined object represents an object to which the deletion information is assigned. FIG. 8 illustrates an example in which the first generation unit 42 generates a second packed object by using four objects to which pieces of the deletion information are not assigned among the objects included in three first packed objects.

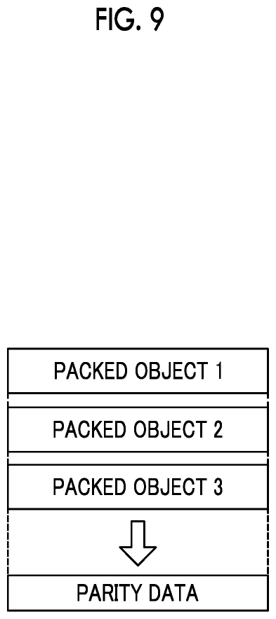

The second generation unit 44 generates parity data by using a plurality of second packed objects generated by the first generation unit 42. As illustrated in FIG. 9, in the present embodiment, the second generation unit 44 generates one piece of parity data, which has the same size as the second packed object, by using three second packed objects generated by the first generation unit 42. The parity data according to the present embodiment is a redundant code capable of restoring, even in a case where one packed object of the three packed objects is lost, the one packed object from the remaining two packed objects and the one piece of parity data.

In a case of generating the parity data by using the plurality of second packed objects, the second generation unit 44 may perform processing of making the sizes of the plurality of second packed objects the same size by adding dummy data to the second packed objects other than the second packed object having a maximum size. Examples of the dummy data include data padded with 0, data padded with 1, and the like.

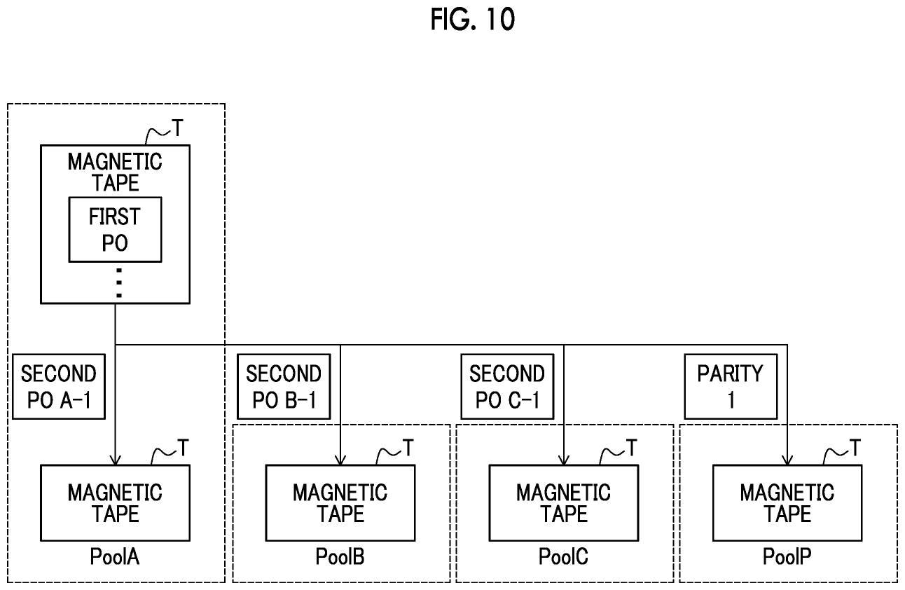

The controller 46 performs control of distributing and recording the plurality of second packed objects and the parity data on the plurality of magnetic tapes T, the parity data being generated by the second generation unit 44 by using the plurality of second packed objects. That is, as illustrated in FIG. 10, the second packed objects are generated by using the first packed objects determined by the determination unit 40 as being regenerated among the packed objects recorded on the migration source tape. In addition, the parity data is generated by using the plurality of second packed objects, and the plurality of packed objects and the parity data are distributed and recorded on the plurality of magnetic tapes T. The example of FIG. 10 illustrates a case where one migration source tape designated as a data migration target belongs to “PoolA”. Further, in FIG. 10, “PO” represents the packed object, and “parity” represents the parity data.

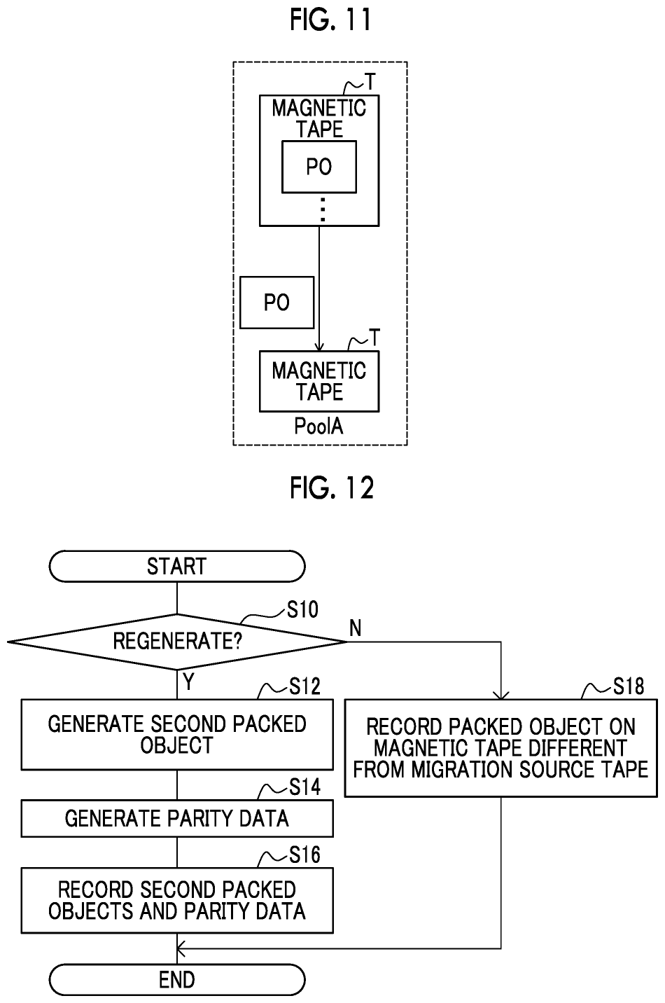

In addition, the controller 46 performs control of recording, for a packed object determined by the determination unit 40 as not being regenerated, the packed object on a magnetic tape T different from the migration source tape. Specifically, as illustrated in FIG. 11, the controller 46 performs control of recording, for a packed object determined by the determination unit 40 as not being regenerated, the packed object on a magnetic tape T which belongs to the same storage pool as the migration source tape and is different from the migration source tape. In FIG. 11, “PO” represents the packed object. That is, in this case, the packed object continues to belong to the same group.

Next, an operation of the information processing apparatus 12 according to the present embodiment will be described with reference to FIG. 12. In a case where the CPU 20 executes the information processing program 30, data migration processing illustrated in FIG. 12 is executed. The data migration processing illustrated in FIG. 12 is executed, for example, in a case where an instruction to start an execution is input via the input device 24. In addition, in this specification, it is assumed that information for specifying one migration source tape designated as a data migration target is also input together with the instruction to start an execution.

In step S10 of FIG. 12, as described above, the determination unit 40 determines whether or not to regenerate a packed object by using objects included in the packed object, for each packed object recorded on one migration source tape designated as a data migration target. Processing of step S12 to step S16 is executed for the packed object determined as being regenerated in step S10. In addition, processing of step S18 is executed for the packed object determined as not being regenerated in step S10.

In step S12, as described above, the first generation unit 42 generates a second packed object by using objects included in the first packed object determined as being regenerated in step S10. In step S14, as described above, the second generation unit 44 generates parity data by using a plurality of second packed objects generated in step S12. In step S16, as described above, the controller 46 performs control of distributing and recording the plurality of second packed objects and the parity data on the plurality of magnetic tapes T, the parity data being generated in step S14 by using the plurality of second packed objects. In a case where the processing of step S16 is completed, data migration processing is completed.

On the other hand, in step S18, as described above, the controller 46 performs control of recording, for a packed object determined in step S10 as not being regenerated, the packed object on a magnetic tape T different from the migration source tape. In a case where the processing of step S18 is completed, data migration processing is completed.

As described above, according to the present embodiment, data migration can be performed from one migration source tape while maintaining redundancy of the packed object recorded on the migration source tape. That is, the number of migration source tapes is one, and thus the number of tape drives 18 used for data migration can be reduced. As a result, it is possible to reduce a frequency of replacement of the magnetic tapes T with respect to the tape drive 18 during data migration. Therefore, it is possible to prevent a data migration time from being increased.

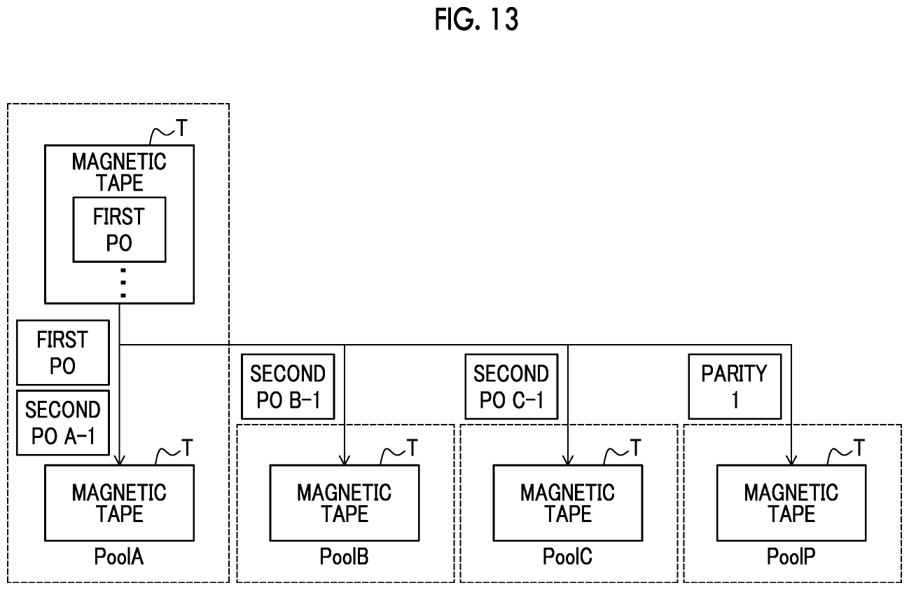

In the embodiment, in a case where a purpose of the data migration is to initialize and reuse the migration source tape, the controller 46 may further perform control of transferring the first packed object used for generating the second packed object to a magnetic tape T different from the migration source tape. Specifically, as illustrated in FIG. 13 as an example, in this case, the controller 46 further performs control of recording the first packed object used for generating the second packed object on a magnetic tape T that belongs to the same storage pool as the migration source tape and is different from the migration source tape. Thereby, even in a case where the migration source tape is initialized, the first packed object recorded on the migration source tape is not lost. Therefore, even in a case where a packed object of a group to which the first packed object recorded on the migration source tape belongs is lost, it is possible to restore the lost packed object. In FIG. 13, “PO” represents the packed object, and “parity” represents the parity data.

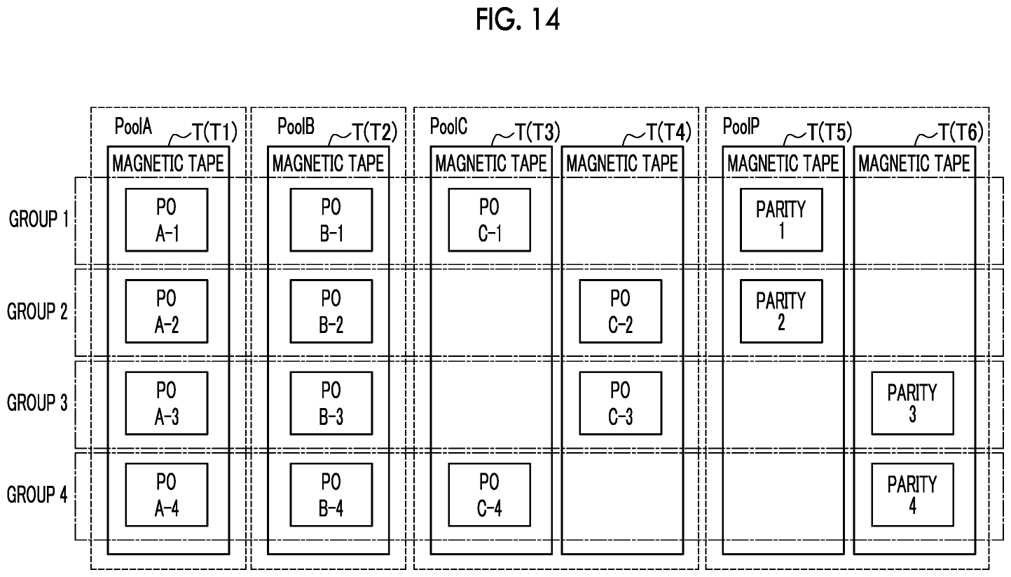

Further, in the example of the embodiment, during the data migration processing of the migration source tape, in a case where there are magnetic tapes that are designated as data migration sources and are designated as data migration targets other than the migration source tape, the controller 46 may derive an order of data migration as described below. That is, in this case, the controller 46 may set, as a data migration order of magnetic tapes designated as data migration sources other than the migration source tape, an order in which the number of recorded packed objects belonging to the same group as the packed objects recorded on the migration source tape during the data migration processing is large. A specific example of the order of data migration will be described with reference to FIG. 14.

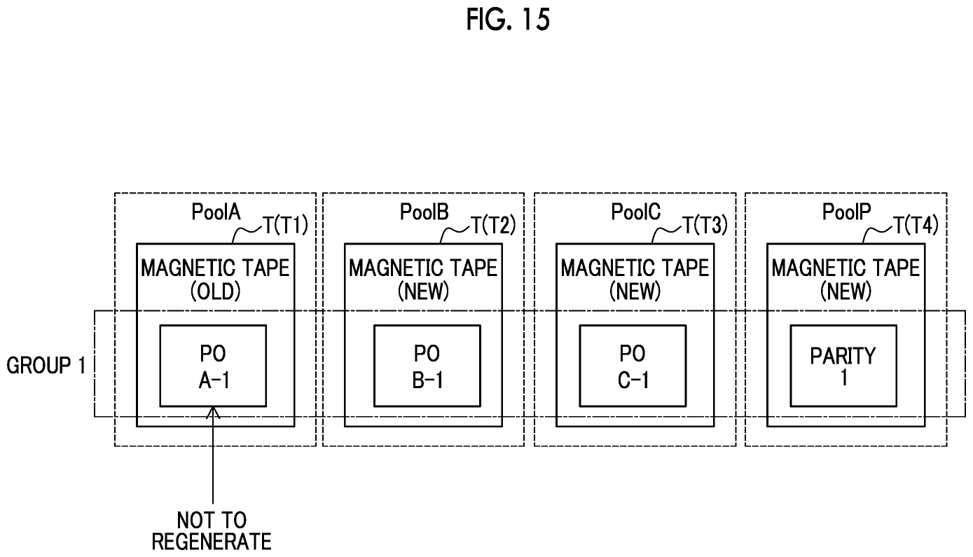

As illustrated in FIG. 14, there are six magnetic tapes T, and in a case where the six magnetic tapes T are distinguished, a number is assigned to the end of the reference numeral. In addition, here, it is assumed that a magnetic tape T1 is a migration source tape during the data migration processing, that magnetic tapes T2 to T6 are magnetic tapes T designated as data migration sources and designated as data migration targets, and that the magnetic tapes T are waiting for data migration. In FIG. 14, “PO” represents a packed object, and “parity” represents parity data. In FIG. 14, the one-letter alphabet after “PO” is for identifying the packed objects in the same group. In FIG. 14, the number after the one-letter alphabet and the number after “parity” are for identifying the group. This notation rule is the same in FIG. 15 which will be described later.

In the example of FIG. 14, packed objects recorded on the migration source tape during the data migration processing are “PO A-1”, “PO A-2”, “PO A-3”, and “PO A-4”. Further, in the example of FIG. 14, in each of the magnetic tapes T2 to T6, for the number of recorded packed objects belonging to the same group as the packed objects recorded on the migration source tape during the data migration processing, four packed objects are recorded on the magnetic tape T2, and two packed objects are recorded on each of the magnetic tapes T3 to T6. Therefore, in this case, the controller 46 sets the magnetic tape T2 as a next data migration target next to the magnetic tape T1, and the magnetic tapes T3 to T6 as next data migration targets next to the magnetic tape T2.

In addition, in the embodiment, the determination unit 40 may perform the following determination in a case where a purpose of data migration is data migration from relatively-old magnetic tapes T to relatively-new magnetic tapes T. That is, in this case, in a case where a packed object belonging to the same group as the packed objects recorded on the migration source tape is recorded on a relatively-new magnetic tape T, the determination unit 40 may determine not to regenerate the packed object by using objects included in the packed object recorded on the migration source tape. A specific example of the determination processing will be described with reference to FIG. 15.

As illustrated in FIG. 15, there are four magnetic tapes T, and in a case where the four magnetic tapes T are distinguished, a number is assigned to the end of the reference numeral. Further, here, it is assumed that a magnetic tape T1 is a migration source tape and is a relatively-old magnetic tape T. Further, here, it is assumed that magnetic tapes T2 to T4 are relatively-new magnetic tapes T. That is, in the example of FIG. 15, all the packed objects belonging to the same group as the packed object recorded on the migration source tape are recorded on the relatively-new magnetic tapes T. Therefore, in this case, the determination unit 40 determines not to regenerate the packed objects by using objects included in the packed object recorded on the migration source tape. In a case where not all the packed objects belonging to the same group as the packed object recorded on the migration source tape but packed objects of which the number is equal to or larger than a certain number are recorded on the relatively-new magnetic tapes T, the determination unit 40 may determine not to regenerate the packed objects by using objects included in the packed object recorded on the migration source tape.

Further, in the embodiment, for example, as a hardware structure of a processing unit that executes various processing, such as the determination unit 40, the first generation unit 42, the second generation unit 44, and the controller 46, the following various processors may be used. The various processors include, as described above, a CPU, which is a general-purpose processor that functions as various processing units by executing software (program), and a dedicated electric circuit, which is a processor having a circuit configuration specifically designed to execute a specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external apparatus via a network.

What is claimed is:

1. An information processing apparatus comprising:
at least one processor,
wherein the processor is configured to:
determine, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data;
generate a second packed object by using objects included in a first packed object determined as being regenerated;
generate parity data by using a plurality of second packed objects;
perform control of distributing and recording the plurality of second packed objects and the parity data on the plurality of magnetic tapes; and
perform control of recording a packed object determined as not being regenerated on a magnetic tape different from the data-migration-source magnetic tape.

2. The information processing apparatus according to claim 1,
wherein the processor is configured to:
further transfer the first packed object used for generating the second packed object to a magnetic tape different from the data-migration-source magnetic tape in a case where a purpose of data migration is to initialize and reuse the data-migration-source magnetic tape.

3. The information processing apparatus according to claim 2, wherein
the plurality of packed objects and the parity data generated from the plurality of packed objects are regarded as one group, and
the processor is configured to:
set, in a case where there are magnetic tapes that are designated as data migration sources and are designated as data migration targets other than the data-migration-source magnetic tape, during data migration processing of the data-migration-source magnetic tape, as a data migration order of magnetic tapes designated as data migration sources other than the data-migration-source magnetic tape, an order in which the number of recorded packed objects belonging to the same group as the packed object recorded on the data-migration-source magnetic tape during the data migration processing is large.

4. The information processing apparatus according to claim 1, wherein
the plurality of packed objects and the parity data generated from the plurality of packed objects are regarded as one group, and
the processor is configured to:
determine, in a case where a purpose of data migration is data migration from relatively-old magnetic tapes to relatively-new magnetic tapes, not to regenerate a packed object by using objects included in the packed object recorded on the data-migration-source magnetic tape in a case where a packed object belonging to the same group as the packed objects recorded on the data-migration-source magnetic tape is recorded on a relatively-new magnetic tape.

5. The information processing apparatus according to claim 1,
wherein the processor is configured to:
determine whether or not to regenerate a packed object by using objects included in the packed object, based on a deletion rate of the objects in the packed object recorded on the data-migration-source magnetic tape.

6. An information processing method executed by a processor of an information processing apparatus, the method comprising:
determining, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data;
generating a second packed object by using objects included in a first packed object determined as being regenerated;
generating parity data by using a plurality of second packed objects;
performing control of distributing and recording the plurality of second packed objects and the parity data on the plurality of magnetic tapes; and
performing control of recording a packed object determined as not being regenerated on a magnetic tape different from the data-migration-source magnetic tape.

7. A non-transitory computer-readable storage medium storing an information processing program for causing a processor of an information processing apparatus to execute a process comprising:
determining, for each of a plurality of packed objects recorded on one data-migration-source magnetic tape designated as a data migration target among a plurality of magnetic tapes on which the plurality of packed objects and parity data generated by using the plurality of packed objects are distributed and recorded, whether or not to regenerate the packed objects by using objects included in the packed objects, the plurality of packed objects being obtained by grouping one or more objects including data and metadata related to the data;
generating a second packed object by using objects included in a first packed object determined as being regenerated;
generating parity data by using a plurality of second packed objects;
performing control of distributing and recording the plurality of second packed objects and the parity data on the plurality of magnetic tapes; and
performing control of recording a packed object determined as not being regenerated on a magnetic tape different from the data-migration-source magnetic tape.
